(19) United States
(12) Patent Application Publication
(10) Pub. No.: US 2009/0063980 A1
(43) Pub. Date: Mar. 5, 2009

(54) METHOD AND APPARATUS FOR PLAYBACK OF MULTI-PART MEDIA CONTENT

(75) Inventors: Peter Rossi, Mountain View, CA (US); William Bull, Campbell, CA (US); Policarpo Wood, Cupertino, CA (US); Eric James Hope, Cupertino, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: APPLE INC., Cupertino, CA (US)

(21) Appl. No.: 11/876,551

(22) Filed: Oct. 22, 2007

Related U.S. Application Data
(60) Provisional application No. 60/969,802, filed on Sep. 4, 2007.

(51) Int. Cl. G06F 3/048

(52) U.S. Cl. 715/721

(57) ABSTRACT

The individual parts of a media presentation are associated with one another, and in addition to maintaining pointers in individual parts which indicate the last point at which playback was stopped, a pointer is maintained for the “container” created by the association. This pointer indicates the last part in the “container” that was played. When the presentation is played back, the user can select a particular part or can select “resume.” If “resume” is selected, the pointer is retrieved and used to select the part to be played. Within the part, a further pointer may indicate where in the part to begin playback, based on where playback was last stopped.

### CROSS REFERENCE TO RELATED APPLICATION

This claims the benefit of U.S. Provisional Patent Application No. 60/969,802, filed Sep. 4, 2007, which is hereby incorporated by reference herein in its entirety.

### BACKGROUND OF THE INVENTION

This invention relates to the playback of multi-part media content, and particularly to the resumption of playback from the same point at which playback was stopped.

Many types of media content may have multiple parts. For example, an “audiobook”—i.e., a sound recording of a printed book being read aloud—may be broken into chapters, following the original printed book. One common way to divide an audiobook into chapters is to make each chapter its own file, with each file being stored separately, although the audiobook could be a single segmented file.

It is typical that media playback devices and/or software maintains a pointer in each file played which indicates where the last playback stopped, so that when the file is played again, playback will begin where it left off. However, when a single multi-media presentation, such as an audiobook, is divided across a plurality of files or file segments—e.g., one file or file segment per chapter of an audiobook—it typically has been up to the user/listener to remember where he or she left off listening and to select the correct file or file segment to resume playing. At that point, that file or file segment would play from the pointer position, which typically is the place playback last stopped. If the user/listener/viewer does not remember which file or file segment he or she was listening to or viewing, it has been necessary to simply try each file or file segment until the correct one is found.

### SUMMARY OF THE INVENTION

In accordance with the invention, the individual parts of a media presentation are associated with one another, and in addition to maintaining pointers in individual parts which indicate the last point at which playback was stopped, a pointer is maintained for the “container” created by the association. This pointer indicates the last part in the “container” that was played.

Each part may be an individual file, or the entire presentation may be in a single file (or in a number of files smaller than the number of parts), with the file (or files) internally segmented into parts. Each part, whether its own file or a portion of a file, has its own pointer indicating the point at which playback of that part last stopped. If the entire presentation is a single file, then the parts are “associated” by their inclusion in that file, with the file being the aforementioned “container.” If each part is its own file, then the parts are associated with appropriate flags, etc., with the resulting associations forming the “container.” Similarly, if the presentation is in multiple files each of which has multiple parts, the association of the parts as being within the “container” arises from their inclusion in the files and from the association of the files with one another.

In any of these variations, if the user selects playback of the presentation, rather than an individual part of the presentation, playback will begin with the part—e.g., file—indicated by the container-level pointer. Within that part or file, its internal pointer will indicate the point within the part at which playback begins. The user can override this selection by intentionally selecting a particular part, which will play back from the point at which playback of that particular part was last stopped, as indicated by the part's pointer. Once playback of a particular part begins, either because the user has selected that part or because the user selected the presentation as a whole, the user may then be allowed to navigate within the presentation in a conventional manner.

Various alternative embodiments are possible.

In one embodiment, if a media presentation has previously been played, then the playback menu for that presentation may include a “Resume” command or similar command that causes playback to begin in the part indicated by the container-level pointer. The other choices on the playback menu may include the individual parts of the presentation. In this embodiment, if a presentation has not previously been played, the playback menu for that presentation may not have the “Resume” command, but only the other commands.

In another embodiment, the “Resume” command may always appear, but if the presentation has not been played before, the Resume command will simply start playback at the beginning of the presentation. In still another embodiment, the “Resume” command may always appear, but will be nonfunctional if the presentation has not been played before. In such a case, the command may be indicated as being nonfunctional—e.g., by being “grayed out.”

Therefore, in accordance with the present invention, there is provided a method of playing a multi-part media presentation. The method includes associating parts of the multi-part presentation with the presentation, setting a presentation pointer indicating a current part of the multi-part presentation, presenting a menu of commands allowing selection of a part of the multi-part presentation to be played, where the menu includes a command to resume playback of the multi-part presentation, and on invocation of the command to resume playback, retrieving the presentation pointer and playing back the current part.

Media player apparatus operating in accordance with the method is also provided.

### BRIEF DESCRIPTION OF THE DRAWINGS

The above and other advantages of the invention will be apparent upon consideration of the following detailed description, taken in conjunction with the accompanying drawings, in which like reference characters refer to like parts throughout, and in which:

FIG. 1 is a block diagram of a media player which may incorporate the present invention;

FIGS. 2-9 are depictions of representative user interface screens according to one embodiment of the invention; and

FIG. 10 is a flow diagram illustrating an embodiment of the present invention.

### DETAILED DESCRIPTION OF THE INVENTION

The invention will now be described in the context of a dedicated media player which may or may not be portable. However, the invention applies to any device capable of playing media presentations, including personal computers.

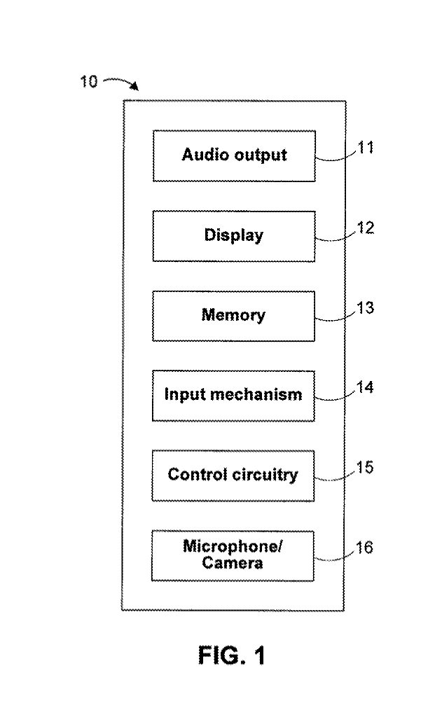

FIG. 1 shows a media player 10, which may or may not be portable, which may incorporate the present invention. Media player 10 may include a suitable amount of memory 13 (e.g., in the gigabyte range) for storing media content, which may include, e.g., audio presentations or video presentations (which may include audio). Audio output 11 may include one or more speakers or headphones for playing back audio content and/or the audio portion of video content. Display 12 allows the playback of the video portion of video content, and also may serve as part of the user interface, displaying command menus, etc. Microphone and/or camera 16 may be provided to allow a user to capture live audio and/or video content for storage in memory 13, while input mechanism 14 provides a way to download or otherwise store content provided from elsewhere. Input mechanism 14 may also include a user command entry interface, including one or more buttons, dials, touchscreens or other controls on device 10 for interacting with control circuitry 15. Control circuitry 15 includes media playback software and/or circuitry for playing back content stored in memory 13. Control circuitry 15 also may include a processor (e.g., a microprocessor or microcontroller) for controlling the user interface, including the menus or other commands displayed on display 12 and the processing of user inputs, and for carrying out the present invention.

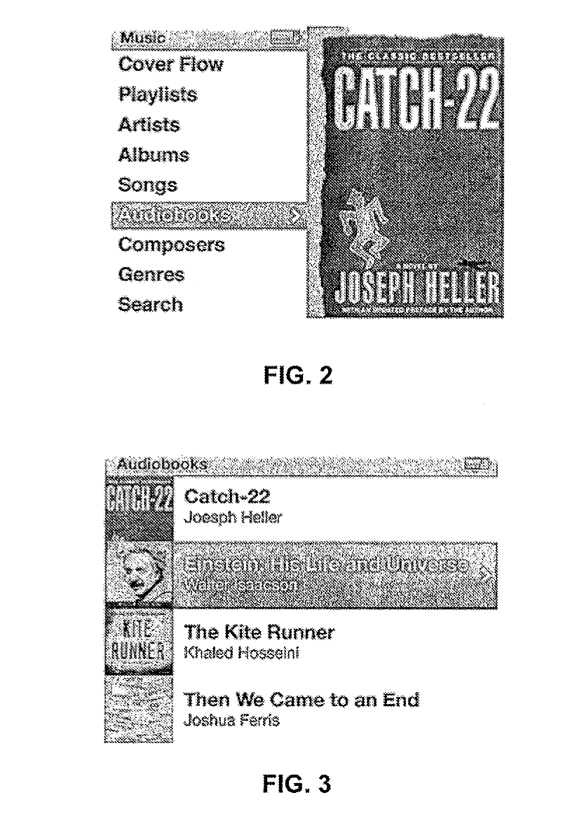

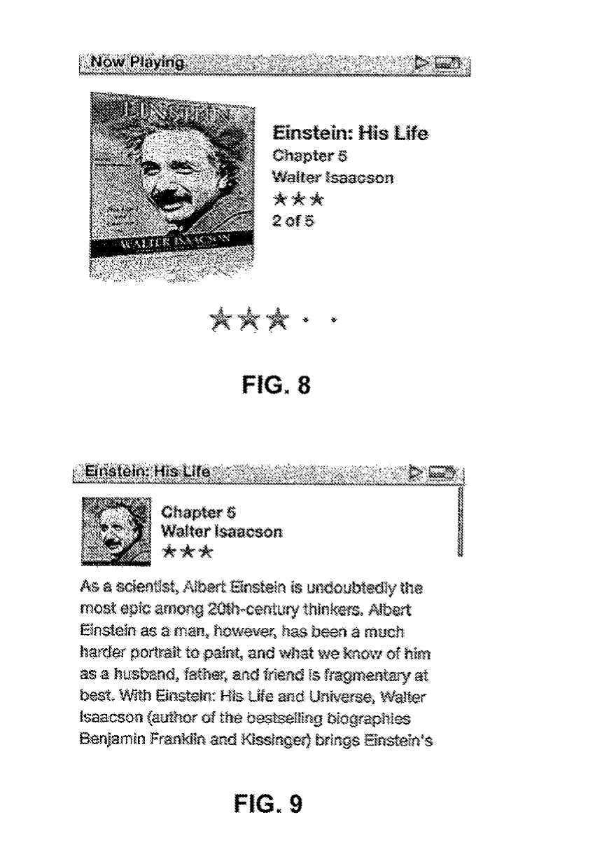

FIGS. 2-9 show one example of how the present invention may operate, in a context where the multi-part media presentation is an audiobook. Thus, in FIG. 2, the screen 20, which may be displayed on display 12, shows a number of available functions 21, of which the user has highlighted the audiobook function at 22. A thumbnail of one available audiobook may be shown in portion 23 of screen 20. After the user has selected the audiobook function, screen 30 of FIG. 3 may be displayed, showing a plurality of audiobooks that are available for playback. In this example, the available audiobooks are shown by title and author, with a thumbnail representation of the book's cover, but the listings shown in FIGS. 2 and 3 are only exemplary.

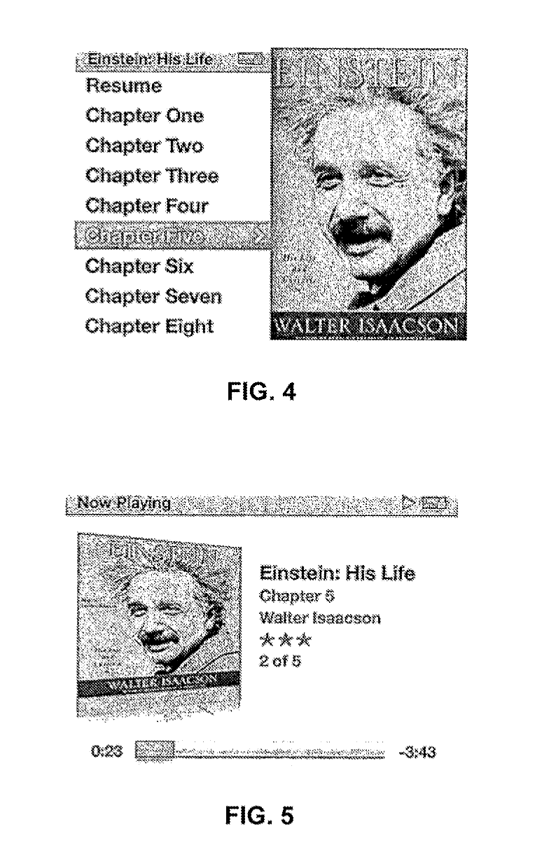

As shown on the exemplary screen 30 in FIG. 3, the user has selected for playback Einstein: His Life and Universe, by Walter Isaacson. As seen in screen 40 of FIG. 4, this book includes at least eight chapters, each of which may be a part within the meaning of the present invention. In addition to the eight chapters, a “Resume” command 41 is displayed above the list of chapters. If the user selects the Resume command, playback will occur as described above. However, in this example, the user has selected a particular part—Chapter Five, and as shown on screen 50 of FIG. 5, Chapter Five begins to play, preferably from the point, if any, at which it last stopped playing, a indicated by a pointer associated with that part as described above.

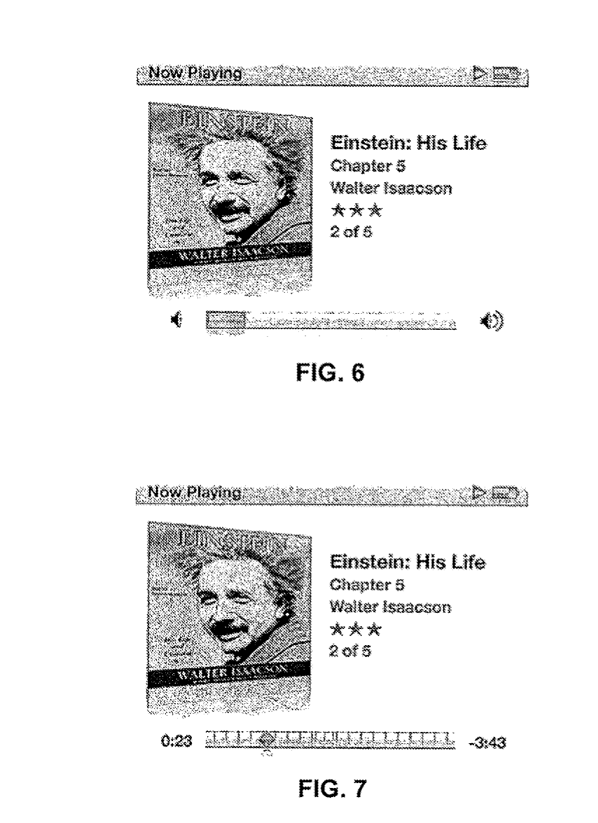

The remaining screens of FIGS. 6-9 show other functions that may be available to a user during playback, such as volume control (screen 60), navigation within the chapter via slide 71 (screen 70), a rating screen 80, and an information screen 90.

Although the example above is based on the audiobook function, it should be noted that the invention may apply to any function that allows selection among a plurality of multi-part media presentations. Thus, for example, among the functions 21 available on screen 20, if one were to choose Playlists, Albums or Genre, the invention may be used to associate, or create a “container” around, the various individual presentations within each playlist, or album, or genre, with each playlist, or album, or genre being considered a multi-part presentation. Resumption of playback of the last-played audio or video presentation would be offered, with each presentation (e.g., song or movie) being a “part” as describe above. Within the resumed presentation of the selected playlist or album or genre, playback would resume from the part's own internal pointer as described above.

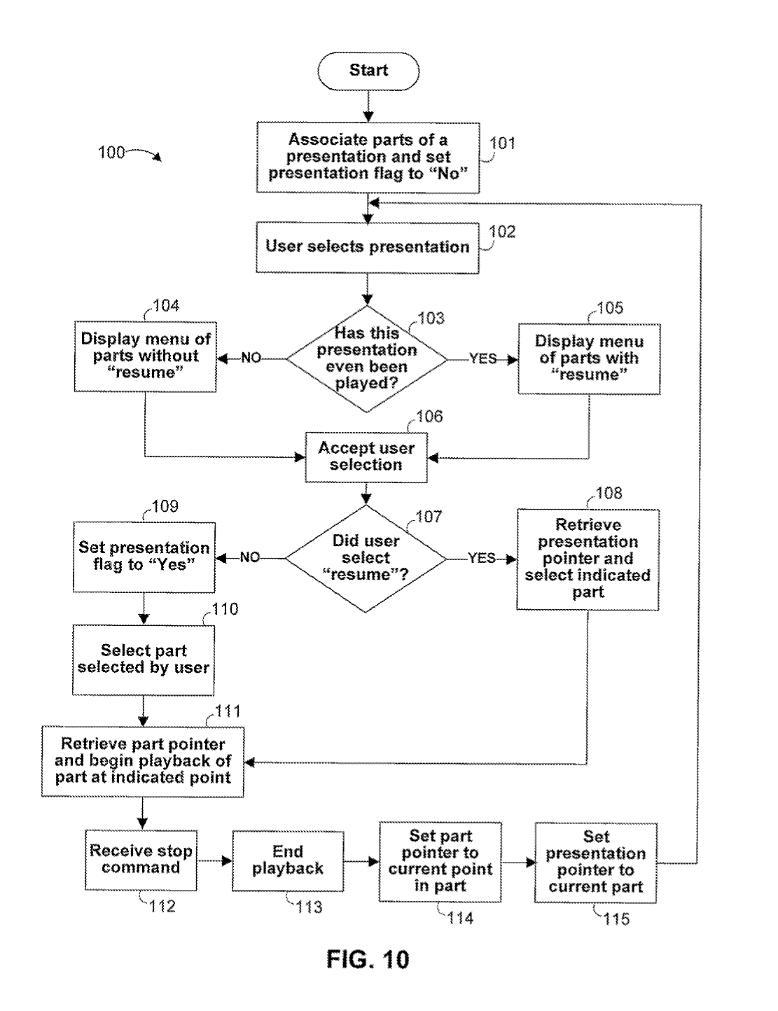

One embodiment of the logical flow 100 of the invention is shown in FIG. 10. Initialization step 101 ordinarily will occur only once, when the parts of a multi-part presentation are first associated with one another as described above. This may include the setting of appropriate flags or pointers. In addition, in initialization step 101 a presentation flag for the entire presentation is set to “No,” signifying that the presentation has never been played.

At step 102, a user has selected the multi-part presentation playback function (e.g., audiobooks) and selected a particular multi-part presentation (e.g., a particular book). At test 103, the method checks the presentation flag of the selected presentation to see if the presentation has ever been played. If the presentation has previously been played, then at step 104 a menu of available parts, including the “Resume” option, is displayed. If the presentation has not previously been played, then at step 105 a menu of available parts, without the “Resume” option, is displayed. Alternatively, as described above (not shown here), the “Resume” option could always be displayed but may be nonfunctional, or may default to the first part, if the presentation has not previously been played.

Regardless of which menu has been displayed, at step 106 the user selection is accepted and at test 107 the method determines whether or not the user selected the “Resume” function. If so, then at step 108 the presentation pointer, which indicates which part of the presentation was the last part being played, is retrieved and the part indicated by the presentation pointer is selected for playback. The method then proceeds to step 111.

If at test 107 the user has not selected the “Resume” function, either because it was not offered (step 104) or because it was offered (step 105) but the user wanted a particular part, then at step 109 the presentation flag is set to “Yes” (an additional test to see if the presentation flag is already set to “Yes”—e.g., where “Resume” was offered but the user did not select it—could be used to save the redundant step of setting the flag again, but is not necessary). Next, at step 110, the part chosen by the user is selected and at the method proceeds to step 111.

At step 111, whether arrived at from step 108 or step 110, the internal part pointer for the selected part is retrieved, and playback is begun at the point indicated by the internal part pointer. Playback continues until a user stop command is entered at step 112.

During playback, the presentation may have advanced to a subsequent part. Therefore, in response to the stop command, playback is ended at step 113, the internal part pointer of the then-active part is set in step 114 to the point within that part at which playback stopped, and the presentation pointer is set in step 115 to the current part. The internal part pointer is stored (not shown) in association with the part, and the presentation pointer is stored (not shown) in association with the presentation. Preferably the presentation pointer and the internal part pointer are stored in a persistent (i.e., non-volatile) manner, from which it will be apparent that the Resume function is persistent and will play the last played file within the container when selected, and that the pointer for an individual part in a container also will remain until that part is played again, at which time its individual pointer is updated and stored.

The method then returns and awaits a further user selection at step 102.

Logic flow 100 shown in FIG. 10 is merely exemplary and other logic flows could be used to achieve the same results described above.

Thus it is seen that a method or apparatus for playing multi-part media presentations, and returning to the same part in such a presentation, has been provided. It will be understood that the foregoing is only illustrative of the principles of the invention, and that various modifications can be made by those skilled in the art without departing from the scope and spirit of the invention, and the present invention is limited only by the claims that follow.

What is claimed is:

1. A method of playing a multi-part media presentation, said method comprising:
associating parts of said multi-part presentation with said presentation;
setting a presentation pointer indicating a current part of said multi-part presentation;
presenting a menu of commands allowing selection of a part of said multi-part presentation to be played, said menu including a command to resume playback of said multi-part presentation; and
on invocation of said command to resume playback, retrieving said presentation pointer and playing back said current part.

2. The method of claim 1 wherein said setting said presentation pointer comprises setting said presentation pointer when stopping playback of said presentation.

3. The method of claim 2 wherein said setting said presentation pointer further comprises setting said presentation pointer to a default part before said presentation has ever been played.

4. The method of claim 3 wherein said default part is a first part.

5. The method of claim 1 wherein:
said menu further includes additional commands to play a particular part; said method further comprising:
setting a respective part pointer indicating a current point in each respective one of said parts; and
on playback of a respective part based on one of (a) said resume command, and (b) one of said additional commands, retrieving said part pointer and beginning playback at said current point.

6. The method of claim 5 wherein said setting said respective part pointer comprises setting said respective part pointer when stopping playback of said respective part.

7. The method of claim 6 wherein said setting said respective part pointer further comprises setting said respective part pointer to a default point before said respective part has ever been played.

8. The method of claim 7 wherein said default point is a beginning of said respective part.

9. Apparatus for playing a playing a multi-part media presentation, said apparatus comprising:
memory for storing at least one multi-part presentation;
an output for presenting (a) said at least one multi-part presentation, and (b) a command menu, to a user;
an input for accepting user commands; and
a processor for:
associating parts of said multi-part presentation with said presentation,
setting a presentation pointer indicating a current part of said multi-part presentation,
presenting a menu of commands allowing selection of a part of said multi-part presentation to be played, said menu including a command to resume playback of said multi-part presentation, and
on invocation of said command to resume playback, retrieving said presentation pointer and playing back said current part.

10. The apparatus of claim 9 wherein said processor sets said presentation pointer when stopping playback of said presentation.

11. The apparatus of claim 10 wherein said processor sets said presentation pointer to a default part before said presentation has ever been played.

12. The apparatus of claim 11 wherein said default part is a first part.

13. The apparatus of claim 9 wherein:
said menu further includes additional commands to play a particular part; and
said processor further:
sets a respective part pointer indicating a current point in each respective one of said parts, and
on playback of a respective part based on one of (a) said resume command, and (b) one of said additional commands, retrieves said part pointer and beginning playback at said current point.

14. The apparatus of claim 13 wherein said processor sets said respective part pointer when stopping playback of said respective part.

15. The apparatus of claim 14 wherein said processor sets said respective part pointer to a default point before said respective part has ever been played.

16. The apparatus of claim 15 wherein said default point is a beginning of said respective part.
